(19) United States
(12) Patent Application Publication
(10) Pub. No.: US 2026/0313188 A1
(43) Pub. Date: Oct. 8, 2026

(54) SYSTEM AND METHOD FOR SYSTEM USER INTERFACE ON A DUAL SCREEN TELEVISION

(71) Applicant: Telly, Inc., Sherman Oaks, CA (US)

(72) Inventors: Ilya Pozin, Los Angeles, CA (US); Shervin Pishevar, Miami, FL (US); Sascha Prueter, Daellikon (ZH); Eric Loes, Seattle, WA (US); Benjamin Hickman, Los Angeles, CA (US); Stephen Shannon, Los Angeles, CA (US); Nanda Rao, Cupertino (CA)

(21) Appl. No.: 19/483,201

(22) PCT Filed: May 9, 2024
(86) PCT No.: PCT/US2024/028509

§ 371 Date: Nov. 10, 2025

Related U.S. Application Data
(60) Provisional application No. 63/465,199, filed on May 9, 2023.

(51) Int. Cl. H04N 21/431; H04N 21/472; H04N 21/485

(52) U.S. Cl. CPC H04N 21/4316; H04N 21/47217; H04N 21/4852; H04N 21/4854

(57) ABSTRACT

A television system may include a housing and a primary screen and a secondary screen in the housing. The secondary screen may have a height that is less than the primary screen. The television system may include an audio source configured to output audio associated with at least one of the first content and the second content. While displaying first content on the primary screen, the television system may be configured to display, on the secondary screen, second content. The second content may include at least one system user interface application. The television system may configure at least one of the first content, the second content, and the audio by using the at least one system user interface application.

### CROSS-REFERENCE TO RELATED APPLICATIONS

This application claims the benefit of U.S. Provisional Patent Application No. 63/465,199 filed May 9, 2023, entitled “SYSTEM AND METHOD FOR CLOSED CAPTIONING ON A DUAL SCREEN TELEVISION”, which is incorporated by reference herein in its entirety.

### FIELD OF THE INVENTION

The present application relates to television displays and, more particularly, to a television that integrates two display portions in a vertical stack that features the ability to present system user interface (“UI”) in one screen while the main program is presented in the other screen.

### BACKGROUND OF THE INVENTION

The proliferation of streaming video applications and the availability of video content online, has led to increased demands being placed on televisions to display traditional television content and make additional streaming or internet-based content available to television users.

Limitations of existing televisions, however, lead to clumsy control and screen overlays designed to present closed captioning text or other interactive content over a program on the screen. These screen overlays may interfere with viewing a currently displayed television program.

Existing televisions generally have incorporated a single display screen to present television content to users. Some televisions have allowed picture in picture for watching programs while navigating menus and split screen functionality that allows users to watch more than one television program at a time. However, this functionality has generally been limited to displaying programs and menus on the same screen at a reduced size. Televisions have also been arranged in arrays to allow single television sets to be physically placed in an array to each display part of a larger picture that is captured in the entire array.

There is a need for a television that allows the presentation of a television program or streaming content, in addition to closed captioning and other content, in such a manner that the additional content, features and functionality do not interfere with the television program. There is a further need for a television that provides access to application programs and application program functionality that does not detract from a program or other content on the primary screen. There is a further need for a television that maximizes the ability to provide system UI in a manner desired by the viewer that does not interfere with the main program, while at the same time allowing additional features, content and interactive functionality without the shortcomings of conventional televisions.

### SUMMARY OF THE INVENTION

According to an embodiment of the present disclosure, a television has two screens that are integrally contained in the housing. One of the screens is the primary screen and the other is smaller secondary screen and may be used to provide ancillary, interactive functionality including the provision of closed captioning text. The secondary screen may be configured to provide one or more closed captioning feeds in different, selected languages. In addition, the location, size, color, font and other attributes of the closed captioning text may be selected by the user. The secondary screen may be configured to display closed captioning along with other information and interactive applications at the same time.

According to an embodiment of the present disclosure, a television provides closed captioning text on a second television screen in the same housing with the main television screen and comprises: a primary screen capable of presenting content in a high-definition format; a secondary screen integral with the television, the secondary screen having the high-definition format and a size that is substantially the same width as the primary screen and between ⅓ and ¼ the height; speakers for outputting sound corresponding to content in the primary and secondary screens; a memory for storing program instructions corresponding to a closed captioning application, an Ad application and a widget application, and storing closed captioning configuration related data; a remote control capable of controlling both screens; at least one HDMI port that conveys closed captioning information corresponding to content for display on the primary screen; and a processor, coupled with the screens, speakers, memory, remote control, and HDMI port and a server over the Internet, the processor capable of executing program instructions for the closed captioning server to: (i) determine whether closed captioning is active or not; (ii) determine the configuration settings for the closed captioning information based on the number of current users, languages and closed captioning preferences of those users; (iii) receive closed captioning data from the HDMI port or the server; (iv) determine synchronization and presenting the closed captioning text in the secondary screen synchronized with the presentation of content on the primary screen; (v) concurrently display content on the primary screen.

According to some embodiments, the television may display widget cards and advertisements on the secondary screen next to the closed captioning. The closed captioning application may determine which languages to present based on configured languages for television users and may present one or more closed captioning streams in the secondary screen depending on the number and identity of viewers. The closed captioning data may be received from one of the HDMI ports or via the internet and may be synchronized between the secondary screen and the corresponding content presented on the primary screen.

According to still another embodiment of the disclosure, a method of operating a television with closed captioning provided on a primary screen that is integrated in the same television housing with a secondary screen, includes: presenting with a media processor audio visual content on a first television screen in a high-definition format synchronized with audio presented on a speaker associated with the television; presenting on a secondary screen, integral with the television, closed captioning text synchronized with the presentation of content on the primary screen, the secondary screen having a high-definition format and a size that is substantially the same width as the primary screen and between ⅓ and ¼ the height; outputting sound from speakers based on content presented in the primary and secondary screens; receiving signals from at least one of a remote control and a microphone capable of controlling both screens; determining whether closed captioning is active or not; determining the configuration settings for the closed captioning information based on the number of current users, languages and closed captioning preferences of those users; receiving closed captioning data from the HDMI port or the server; determining synchronization and presenting the closed captioning text in the secondary screen synchronized with the presentation of content on the primary screen; and concurrently displaying content on the primary screen.

According to an embodiment of the disclosure in which the closed captioning configuration and display system and method finds application, a television provides two integrated television screens. The secondary television screen is approximately ¼ to ⅓ the height of the primary screen which is preferably 16:9. This allows a television viewer to watch a standard 16:9 TV screen while simultaneously watching a smaller, secondary screen for closed captioning and multitasking. This arrangement facilitates providing a full range of interactive content, control and features to users via the provision of closed captioning in the secondary screen along with other applications and information, in a manner that enhances and does not interfere with the content on the primary screen.

According to some embodiments, the integrated television screens may comprise separate television panels integrated into a single television, with or without a soundbar. In other embodiments, for example, a single 4:3 panel may be configured with a physical screen divider and software for dividing the video into two separate integrated screens. According to one embodiment, the HDMI port may deliver video to the 16:9 primary screen only. In other embodiments, the HDMI port may deliver video to the primary and secondary screens.

According to another embodiment of the present disclosure, a television provides general TV system relevant operating information such as volume, closed captioning text and system notifications on a second television screen in the same housing with the main television screen that has a high definition format.

According to some embodiments of the present disclosure, a television system may include a housing and a primary screen in the housing. The primary screen may be configured to present first content. The television system may further include a secondary screen in the housing. The secondary screen may be configured to display second content. The secondary screen may have a height that is less than the primary screen. The television system may include an audio source disposed in the housing. The audio source may be configured to output audio associated with at least one of the first content and the second content.

According to some embodiments of the present disclosure, the television system may include a processor configured to display, on the primary screen, the first content. While displaying the first content on the primary screen, the processor may be configured to display, on the secondary screen, the second content. The second content may include at least one system user interface application. While displaying the first content on the primary screen, the processor may configure at least one of the first content, the second content, and the audio by using the at least one system user interface application.

According to some embodiments of the present disclosure, the at least one system user interface application may include a closed captioning application that configures and/or displays closed captioning associated with the first content displayed on the primary screen. The at least one system user interface application may further include at least one widget card displayed next to the closed captioning application on the secondary screen. The at least one system user interface application may further include an ad widget displayed on the secondary screen with the closed captioning application. The ad widget may be displayed on the secondary screen next to the closed captioning application.

According to some embodiments of the present disclosure, the closed captioning application may determine closed captioning languages to display on the secondary screen based on configured language information for television users stored in a memory of the television system and the current television viewers. The closed captioning data may be synchronized between the secondary screen and the corresponding first content presented on the primary screen. The closed captioning data may be received via one of the HDMI ports of the television system. The operation of the at least one system user interface application does not interfere with the viewing of the first content on the primary screen.

According to some embodiments of the present disclosure, a method of operating a television system is provided. The method includes presenting first content on a primary screen of the television system. The method further includes presenting, on a secondary screen integral with the television system, second content synchronized with the presentation of the first content on the primary screen. The second content may include at least one system user interface application. The secondary screen may have a height that is less than the primary screen. The method may include outputting audio from an audio source based on at least one of the first content and the second content. The method may include configuring at least one of the first content, the second content, and the audio by using the at least one system user interface application while the first content is being displayed on the primary screen.

According to some embodiments of the present disclosure, a television system includes a housing, a primary screen in the housing and a secondary screen in the housing. The primary screen may be configured to present first content and the secondary screen may be configured to display second content. The secondary screen may have a height less than the primary screen. The television system may include an audio source disposed in the housing. The audio source may be configured to output audio associated with at least one of the first content and the second content. The television system may include a processor. The processor may be configured to: display, on the primary screen, the first content; and while displaying the first content on the primary screen: display, on the secondary screen, the second content, the second content including at least one system user interface application; receive a user input command corresponding to the at least one system user interface application displayed on the secondary screen; and in response to receiving the user input command corresponding to the at least one system user interface application displayed on the secondary screen, configure a system configuration characteristic corresponding to at least one of the first content on the primary screen and the audio corresponding to at least the first content on the primary screen by using the at least one system user interface application.

According to some embodiments, the system configuration characteristic is associated with closed captioning. Configuring closed captioning using the at least one system user interface application on the secondary screen includes configuring closed captioning displayed on the secondary screen corresponding to the first content displayed on the primary screen.

According to some embodiments, the system configuration characteristic is associated with system tray. Configuring system tray using the at least one system user interface application on the secondary screen includes configuring applications to be included in a system tray on the secondary screen to provide easy access to most commonly used applications.

According to some embodiments, the system configuration characteristic is associated with display settings. Configuring display settings using the at least one system user interface application on the secondary screen includes configuring brightness, color, layout, scale, resolution, and other parameters of the primary screen.

According to some embodiments, the system configuration characteristic is associated with content navigation. Configuring content navigation using the at least one system user interface application on the secondary screen includes configuring a playback speed of the first content displayed on the primary screen, skipping forward or rewinding a playback of the first content displayed on the primary screen, or selecting the first content to be presented on the primary screen.

According to some embodiments, the system configuration characteristic is associated with display layout. Configuring display layout using the at least one system user interface application on the secondary screen includes configuring layout and orientation of applications displayed on the secondary screen.

According to some embodiments, the system configuration characteristic is associated with volume control. Configuring volume control using the at least one system user interface application on the secondary screen includes configuring a volume of the audio that corresponds to the primary screen.

According to some embodiments, the operation of the at least one system user interface application does not interfere with viewing of the first content on the primary screen.

According to some embodiments of the present disclosure, a method of operating a television system is provided. The method includes: presenting first content on a primary screen of the television system; presenting, on a secondary screen integral with the television system, second content synchronized with the presentation of the first content on the primary screen, the second content including at least one system user interface application, the secondary screen having a height less than the primary screen; outputting audio from an audio source based on at least one of the first content and the second content; receiving a user input command corresponding to the at least one system user interface application displayed on the secondary screen; and in response to receiving the user input command corresponding to the at least one system user interface application displayed on the secondary screen, configuring a system configuration characteristic corresponding to at least one of the first content displayed on the primary screen and the audio corresponding to at least the first content on the primary screen by using the at least one system user interface application.

### BRIEF DESCRIPTION OF THE FIGURES

The above described features and advantages of the present disclosure will be more fully appreciated with reference to the following figures.

FIG. 1 depicts a television that integrates two distinct screens and concurrent functionality according to an embodiment of the present disclosure.

FIG. 2 depicts a functional bock diagram of a television that integrates two distinct screens and concurrent functionality for system UI on one of the screens according to an embodiment of the present disclosure.

FIG. 3 depicts a method of configuring and presenting closed captioning to users on a secondary screen of a television that integrates two distinct screens according to an embodiment of the present disclosure.

FIG. 4 depicts a functional block diagram of a closed captioning program that determines viewer and configuration information to facilitate selecting and presenting closed captioning on a secondary screen a television that integrates two distinct screens according to an embodiment of the present disclosure.

FIG. 5 depicts an illustrative view of system UI presented on a secondary screen of a television that integrates two distinct screens.

FIG. 6 depicts an illustrative view of a configuration of multiple users with different language profiles being served by multiple audio output streams in their preferred language and multiple closed captioning streams according to an embodiment of the present disclosure.

### DETAILED DESCRIPTION

According to an embodiment of the present disclosure, a television has two screens that are integrally contained in the housing. One of the screens is a primary screen. The other is smaller secondary screen and may be used to provide system UI (e.g., closed captioning, navigational menus, volume, system trays, display settings, widgets, advertising) according to user configurations.

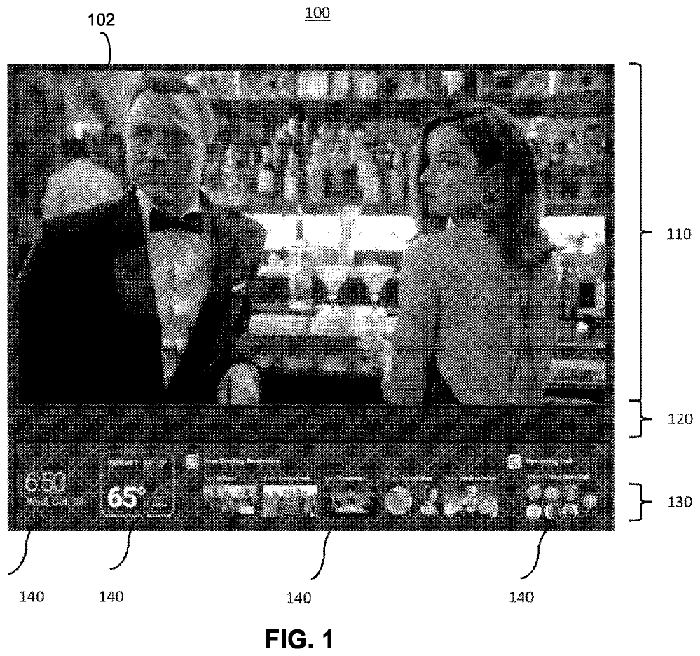

FIG. 1 depicts a television 100 that integrates two distinct screens and concurrent functionality according to an embodiment of the present disclosure. Referring to FIG. 1, the television includes an overall housing 102 and a primary screen 110 and a secondary screen 130. The primary and secondary screen may be separated by an optional sound bar 120. Alternatively, the screens may be separated by a physical divider or placed adjacent to one another. The secondary screen may be portioned into areas where the screen output is determined by widget programs 140, that present information, interactive or otherwise to users. The widget programs 140 may also be referred to as system UI applications.

According to an embodiment of the disclosure, the secondary television screen is approximately ¼ to ⅓ the height of the primary screen which preferably has an aspect ratio of 16:9. This allows a television viewer to watch a standard 16:9 primary TV screen while simultaneously watching a smaller, secondary screen for multitasking or configuring the viewing experience (including but not limited to configuring the video/content displayed on the primary screen and/or the secondary screen, the audio being played). Additionally, the secondary screen can be on while leaving the primary screen off for media consumption including text, graphics, advertising, video, and audio. This arrangement facilitates providing a full range of interactive content, control and features to users via the provision of system UI applications that may control either screen or both screens simultaneously. Such system UI applications enable the linking of content, control and features between the two screens and ancillary devices such a sound bar, which may also be integrated into the television.

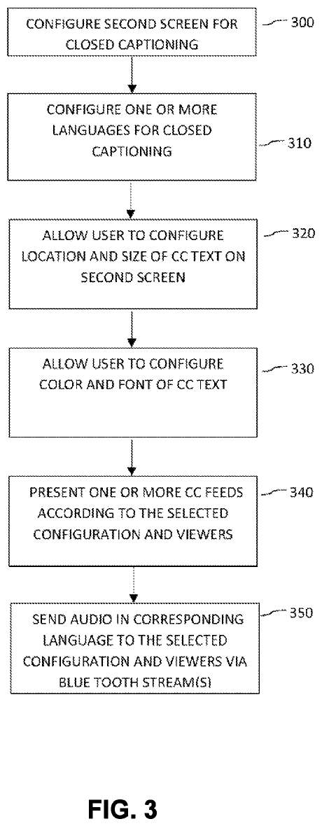

One example of system UI application is the closed captioning application, as will be described below with reference to FIGS. 3-6. Another example of system UI application is the display settings application. A user, while watching the content displayed on the primary screen, may be able to use the display settings application displayed on the secondary screen to configure the brightness, color, layout, scale, resolution, and other parameters of the primary screen. In another example, a user, while watching the content displayed on the primary screen, may be able to use a system UI application displayed on the secondary screen to configure the content displayed on the primary screen and/or the secondary screen. For example, the user may be able to use the system UI application to configure the playback speed of the content displayed on the primary screen, to skip forward or rewind the playback of the content displayed on the primary screen, or to select the content to be presented on the primary screen. The user may be able to use the system UI application to configure the applications presented on the secondary screen (e.g., configuring the layout and orientation of the applications). In yet another example, a user, while watching content displayed on the primary screen, may use a system UI application displayed on the secondary screen to adjust the audio of the television system. The user may use the system UI application to adjust the volume of the audio, including muting and unmuting the audio. The user may use the system UI application to configure the sound effect of the audio, e.g., echo, equalization, pitch shift, time stretching, robotic voice effects, 3D audio effects, etc. A user may interact with the system UI applications through any user interaction means, such as remote control, touch screen, keyboard, mouse, voice/gesture detection, etc. As shown above, the presentation and/or interaction of the system UI applications are conducted on the secondary screen so that the content being displayed on the primary screen is not interfered or disrupted.

According to some embodiments, the integrated television screens may comprise separate television panels integrated into a single television, with or without a soundbar. In other embodiments, for example, a single 4:3 panel may be configured with a physical screen divider and hardware and software provisioning to divide the television into two separate integrated screens. According to one embodiment, HDMI ports may deliver video to the primary screen only. In other embodiments, the HDMI ports may deliver video to the primary and secondary screens.

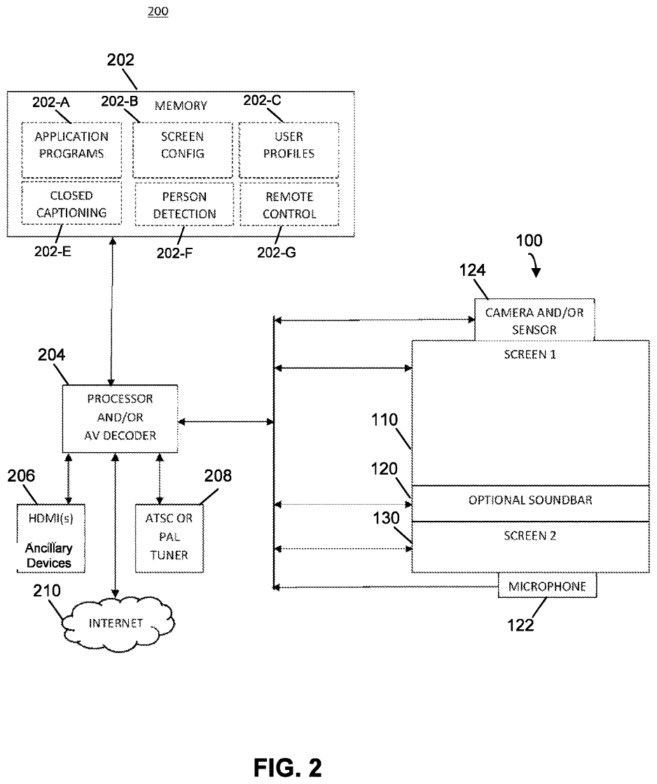

FIG. 2 depicts a functional bock diagram of a television that integrates two distinct screens and concurrent functionality according to an embodiment of the present disclosure. Referring to FIG. 2, a television 100 according to an embodiment of the present disclosure incorporates a processor 204 coupled with a memory 202, HDMI ports 206, an ATSC or PAL tuner 208, a camera and/or sensor 124, a microphone 122, speakers or an optional soundbar (e.g., the audio source 120), the Internet 210, and two distinct screens (e.g., the primary screen 110 and the secondary screen 130) as described above. The memory 202 may store programs, that include program instructions that are executed by the processor 204 to enable the various functionalities of the television 100. The memory 202 may include, for example, application programs 202-A, a closed captioning program 202-E, a screen configuration program 202-B, a person detection program 202-F, a user profile program 202-C, and a remote control program 202-G, among others.

The HDMI ports 206 enable A/V devices to be connected to the television 100, including DVD players, DVRs, sound bars, streaming boxes, A/V Receivers, gaming consoles and other equipment. ATSC or PAL tuners 208 may be incorporated into the television 100 to allow the television to receive over the air or certain cable broadcasts and present them on the primary screen 110, or on the secondary screen 130.

A microphone 122 may be included in the television 100 to allow the user to provide spoken commands to the television, to allow for video conferencing, and to allow other audio visual applications. A camera 124 may also be provided to facilitate functionality such as to permit video conferencing and for gesture and motion recognition and a sensor [124] may also be provided to facilitate functionality such as determining the number of viewers of the television system 100, among other features. The screens (e.g., primary screen 110 and secondary screen 130) are distinct and render images corresponding to content from the HDMI ports 206, from the tuners 208, from the Internet 210, streaming or other interconnected devices. In addition, the content of the screens may be determined by application programs 202-A or any of the other programs stored in memory 202 and executed by the processor 204. The speakers and/or optional soundbar 120 are used to provide audio output corresponding to content displayed on the screens or enabled through the application programs 202-A or other programs provided on the television 100. The television 100 may also incorporate a RF receive or IR port for receiving signals from a remote control used to control the television.

The processor 204 may be a single micro-processor, multiple processors, or a processor and a coprocessor. In one embodiment, a primary micro-processor may be used to render and operate the user interface while a second processer maybe used to decode video, for example H.264 format outputting a signal via HDMI. The processor(s) 204 may support all functionality needed to operate the display screens of the television 100, and synchronize images with audio output, including rendering, video decoding, audio decoding, audio visual synchronization control, motion estimation and motion compensation, picture quality, time stamp normalization, frame rate control, and over the air updates. In addition, the processor(s) 204 execute program instructions from memory 202 to enable applications to be presented on one or both screens of the television 100, and to permit use of the speakers, microphone, cameras, internet connection, remote control, and two-way communication with ancillary devices connected to the television, such as content streaming hardware.

According to an embodiment of the present disclosure, the processor 204 may be an application processor designed specifically for smart display applications, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interphases such as for Ethernet, USB, SDIO 3.0, eMMC 5.1, SDIO/SD card controller, UART, I2C, highspeed SPI PWMs and an IR blaster. The processor 204 may be distributed or a system on a chip and may interface with additional memory and components of the television.

FIG. 3 depicts a method of selecting and presenting closed captioning to users on a secondary screen corresponding to content being presented on a primary screen of a television that integrates two distinct screens according to an embodiment of the present disclosure. In some embodiments, closed captioning may be presented by a system UI referred to as closed captioning application. However, while closed captioning system configuration is described herein, it is merely for exemplary purposes and other system configurations such as navigational menus, volume, system trays, system/display settings or any other type of configuration available for single TV configurations, can be implemented as an alternative using similar processes. Referring to FIG. 3, in 300, the secondary screen is configured for closed captioning. This may be done by the user using the remote control and selecting closed captioning functionality. The setting may be stored in the memory of the television. There may be a number of user configurable closed captioning settings. For example, in 310, the user may select more than one language for closed captioning subtitles. Additionally, each user in each user's profile may have the option of selecting a closed captioning language that is used when closed captioning is selected and that user is a viewer. When more than one closed captioning stream is selected, closed captions for more than one language may be presented to the user.

In 320, the user may optionally be given configuration options to choose the location and size of the closed captioning text on the secondary screen.

In 330, the user may optionally be given the option to determine the color and font of the closed captioning.

In 340, the processor determines that closed captioning has been selected and presents one or more closed captioning streams in the secondary screen according to the configuration settings and/or viewer profiles of viewers present.

In 350, the processor determines that more than one user is present with different language requirements. When a current program has multiple audio streams available in different languages, and multiple viewers are connected via Bluetooth and have different language preferences stated in their profile that align with the available audio streams, the processor selects the audio stream associated with each user connected via Bluetooth and provides the audio stream concurrently with other users in the respective language required by each user.

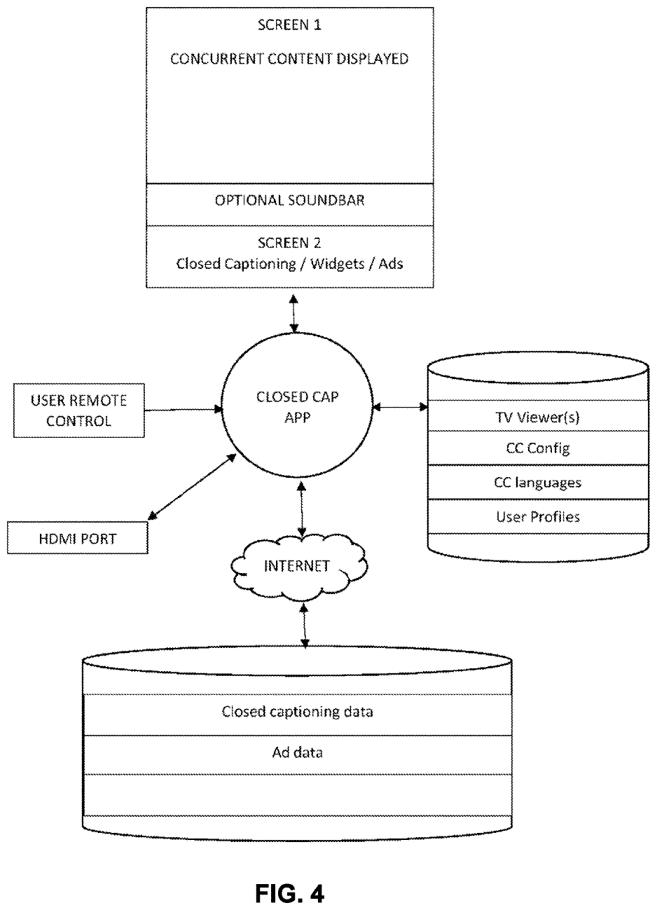

FIG. 4 depicts a functional block diagram of a closed captioning application program that determines whether to implement closed captioning on a secondary screen and the configuration of such closed captioning on a television that integrates two distinct screens according to an embodiment of the present disclosure. The closed captioning application program may be presented as a system UI on the secondary screen. Referring to FIG. 4, a remote control is used to interact with the television to determine content displayed in the primary screen and closed captioning options and presentation of closed captioning to users of the television. The closed captioning application includes program instructions resident in memory that interact with data in memory related to closed captioning configurations for viewers. For example, closed captioning related data may include: configuration data for the current television viewers including their preferences for the location of the closed captions on the secondary screen, the size of the text, and the location of widgets and advertising in relation to where the closed captioning text will be presented on the secondary screen. The closed captioning data may further include data related to whether a television user has made closed captioning active or inactive; language information for each viewer, and user profile settings, which may include information about closed captioning or closed captioning language preferences.

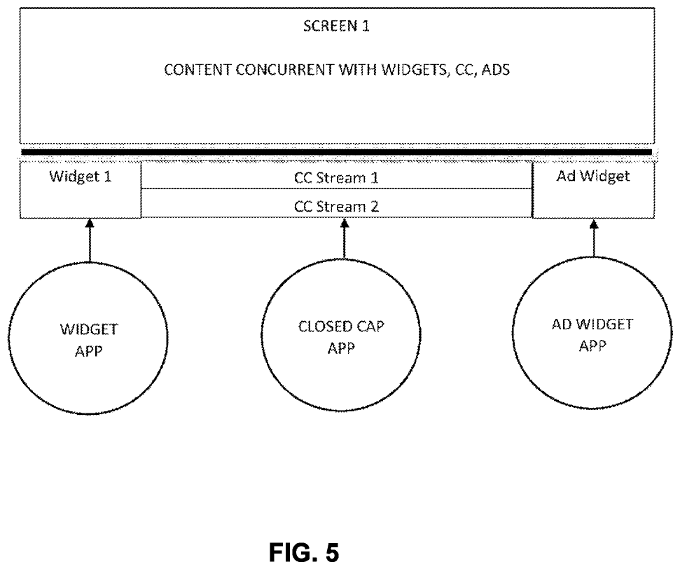

The closed captioning data itself may come from an HDMI port for HDMI content presented on the primary screen. The processor will present the media on the primary screen and present synchronized closed captioning via the closed captioning application to the secondary screen. When the content on the primary screen comes from other sources, such as the Internet, the source of closed captioning data may similarly be from the Internet content source. Ads and data supporting widgets may still be presented to the television users on the secondary screen while closed captioning is active, as shown illustratively in FIG. 5.

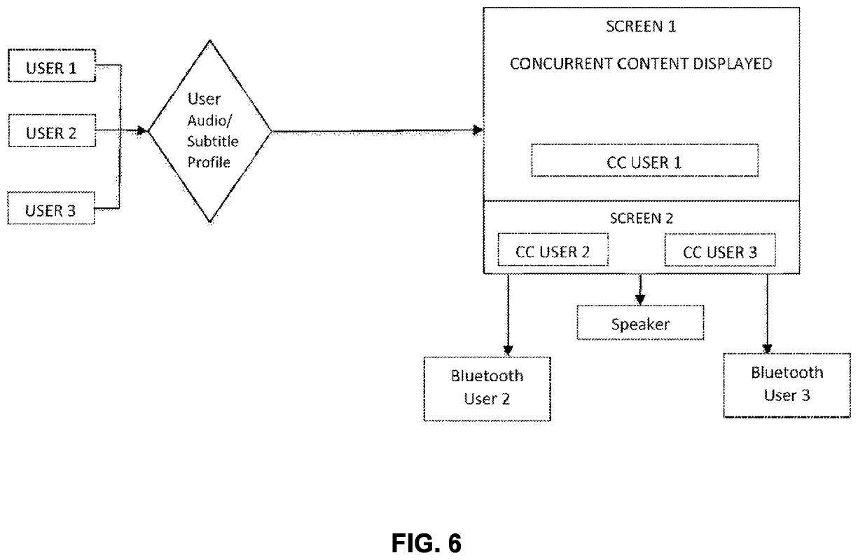

FIG. 6 depicts an illustrative view of a configuration of multiple users with different language profiles being served by multiple audio output streams in their preferred language and multiple closed captioning streams according to an embodiment of the present disclosure. Referring to FIG. 6, multiple users with respective language profiles may use the dual screen television. The closed captioning app may present multiple closed captioning feeds in different languages distributed among the primary screen and/or the secondary screen. In addition, when users having different language profiles are connected with Bluetooth headsets to the television, the processor may be configured to select the appropriate audio stream in the appropriate language for the respective Bluetooth connected users when different language streams are available for a given program being viewed. The processor in this configuration will select and process multiple audio streams and broadcast them to respective users and in addition the processor may send some of the audio to the main speaker(s) associated with the television in the selected or configured language.

While particular embodiments have been shown and described herein, it will be understood by those having ordinary skill in the art that changes may be made to those embodiments without departing from the spirit and scope of the disclosure.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIGS. 3 and 6, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 5.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A television system comprising:
a housing;
a primary screen in the housing, the primary screen configured to present first content;
a secondary screen in the housing, the secondary screen configured to display second content, the secondary screen having a height less than the primary screen;
an audio source disposed in the housing, the audio source configured to output audio associated with at least one of the first content and the second content; and
a processor configured to:
display, on the primary screen, the first content; and
while displaying the first content on the primary screen:
display, on the secondary screen, the second content, the second content including at least one system user interface application;
receive a user input command corresponding to the at least one system user interface application displayed on the secondary screen; and
in response to receiving the user input command corresponding to the at least one system user interface application displayed on the secondary screen, configure a system configuration characteristic corresponding to at least one of the first content on the primary screen and the audio corresponding to at least the first content on the primary screen by using the at least one system user interface application.

2. The television system according to claim 1, wherein the system configuration characteristic is associated with closed captioning, wherein configuring closed captioning using the at least one system user interface application on the secondary screen includes configuring closed captioning displayed on the secondary screen corresponding to the first content displayed on the primary screen.

3. The television system according to claim 1, wherein the system configuration characteristic is associated with system tray, wherein configuring system tray using the at least one system user interface application on the secondary screen includes configuring applications to be included in a system tray on the secondary screen to provide easy access to most commonly used applications.

4. The television system according to claim 1, wherein the system configuration characteristic is associated with display settings, wherein configuring display settings using the at least one system user interface application on the secondary screen includes configuring brightness, color, layout, scale, resolution of the primary screen.

5. The television system according to claim 1, wherein the system configuration characteristic is associated with content navigation, wherein configuring content navigation using the at least one system user interface application on the secondary screen includes configuring a playback speed of the first content displayed on the primary screen, skipping forward or rewinding a playback of the first content displayed on the primary screen, or selecting the first content to be presented on the primary screen.

6. The television system according to claim 1, wherein the system configuration characteristic is associated with display layout, wherein configuring display layout using the at least one system user interface application on the secondary screen includes configuring layout and orientation of applications displayed on the secondary screen.

7. The television system according to claim 1, wherein the system configuration characteristic is associated with volume control, wherein configuring volume control using the at least one system user interface application on the secondary screen includes configuring a volume of the audio that corresponds to the primary screen.

8. The television system according to claim 1, wherein operation of the at least one system user interface application does not interfere with viewing of the first content on the primary screen.

9. A method of operating a television system, the method comprising:
presenting first content on a primary screen of the television system;
presenting, on a secondary screen integral with the television system, second content synchronized with the presentation of the first content on the primary screen, the second content including at least one system user interface application, the secondary screen having a height less than the primary screen;
outputting audio from an audio source based on at least one of the first content and the second content;
receiving a user input command corresponding to the at least one system user interface application displayed on the secondary screen; and
in response to receiving the user input command corresponding to the at least one system user interface application displayed on the secondary screen, configuring a system configuration characteristic corresponding to at least one of the first content displayed on the primary screen and the audio corresponding to at least the first content on the primary screen by using the at least one system user interface application.

10. The method according to claim 9, wherein the system configuration characteristic is associated with closed captioning, wherein configuring closed captioning using the at least one system user interface application on the secondary screen includes configuring closed captioning displayed on the secondary screen corresponding to the first content displayed on the primary screen.

11. The method according to claim 9, wherein the system configuration characteristic is associated with content navigation, wherein configuring content navigation using the at least one system user interface application on the secondary screen includes configuring a playback speed of the first content displayed on the primary screen, skipping forward or rewinding a playback of the first content displayed on the primary screen, or selecting the first content to be presented on the primary screen.

12. The method system according to claim 9, wherein the system configuration characteristic is associated with volume control, wherein configuring volume control using the at least one system user interface application on the secondary screen includes configuring a volume of the audio that corresponds to the primary screen.

13. The method according to claim 9, wherein the system configuration characteristic is associated with system tray, wherein configuring system tray using the at least one system user interface application on the secondary screen includes configuring applications to be included in a system tray on the secondary screen to provide easy access to most commonly used applications.

14. The method according to claim 9, wherein the system configuration characteristic is associated with display settings, wherein configuring display settings using the at least one system user interface application on the secondary screen includes configuring brightness, color, layout, scale, resolution of the primary screen.

15. The method according to claim 9, wherein operation of the at least one system user interface application does not interfere with viewing of the first content on the primary screen.

16. The method according to claim 9, wherein the system configuration characteristic is associated with display layout, wherein configuring display layout using the at least one system user interface application on the secondary screen includes configuring layout and orientation of applications displayed on the secondary screen.
